(19) United States
(12) Patent Application Publication
(10) Pub. No.: US 2023/0004619 A1
(43) Pub. Date: Jan. 5, 2023

(54) PROVIDING SMART WEB LINKS

(71) Applicant: VMWARE, INC., Palo Alto, CA (US)

(72) Inventor: Rohit Pradeep Shetty, Bangalore (IN)

(21) Appl. No.: 17/402,656

(22) Filed: Aug. 16, 2021

(30) Foreign Application Priority Data
Jul. 2, 2021 (IN) 202141029824

(51) Int. Cl. G06F 16/957

(52) U.S. Cl. CPC G06F 16/9574

(57) ABSTRACT

Systems and methods presented herein provide smart web links that display the most relevant portion of a shared web page based on the context in which the web page is shared. An agent on a user device can detect a uniform resource locator (“URL”) shared on a communication channel. The agent can send the URL and content from the communication channel to a server. The server can retrieve a web page of the URL and identify sections of it. The server can compare the sections to the communication content to determine which section is the most semantically similar. The server can modify the web page to generate a custom preview, highlight the semantically similar content, and cause the web page to automatically scroll to the highest scoring section. The agent can change the shared URL to a new URL that directs to the modified web page.

### RELATED APPLICATION

Benefit is claimed under 35 U.S.C. 119(a)-(d) to Foreign Application Serial No. 202141029824 filed in India entitled “PROVIDING SMART WEB LINKS”, on Jul. 2, 2021, by VMware, Inc., which is herein incorporated in its entirety by reference for all purposes.

### BACKGROUND

Web Uniform Resource Locators (“URLs”) are widely shared in both the personal and professional space. The recipient usually clicks out of the shared link and visits the corresponding webpage. It is then up to the recipient to identify what, if any, portions of the web page are relevant. Also, when a URL is shared on most communication platforms, a preview of the web page is generated for the recipients. This preview is generally related to the primary purpose or topic of the web site.

However, in some cases, the entire webpage might not be of interest to the recipient or relevant to the context of an ongoing discussion where the URL was shared. For example, an employee can share a web page link consisting of numerous paragraphs, but only a few of them are relevant to the intended recipient or an ongoing discussion with the recipient. Recipients currently either have to manually scroll through the page to find areas of interest or resort to techniques like using the browsers search feature to look for keywords. The recipient often must read through large amounts of content before finding the relevant portion. This wastes time for the recipient and causes frustration, which often causes the recipient to give up or not even attempt to find the relevant content. This can be particularly true where the preview of the web site presented to the recipient has nothing to do with the context of the conversation.

As a result, a need exists for creating custom web link previews making it easier for recipients of shared URLs to identify relevant content on the corresponding web page.

### SUMMARY

Examples described herein include systems and methods for providing smart web links that make it easier for users to identify relevant content. In an example, users can share messages on a communication channel, such as email, instant messaging, social media posting, and the like. One user can share a URL for a web page on the communication channel. An agent on a user device that receives the shared URL can detect the URL in the communication channel. The agent can send the URL and the shared messages to a server.

The server can use the URL to retrieve its corresponding web page. Upon receiving the web page, the server can identify sections of the web page. For example, where the web page is received as a Hypertext Markup Language (“HTML”) file, the server can identify HTML elements tags in the file that indicate a section. When the web page is actually multiple pages, the different sections can correspond to smaller portions, such as a few paragraphs, of the overall webpage. The server can process content from the web page sections and the shared messages to prepare them for a comparison. For example, the server can clean the content by making all text lower case, tokenizing, removing stop words like “the,” “is,” “at,” “which,” and “on,” removing punctuation, and lemmatizing. The server can then implement natural language processing (“NLP”) techniques on the cleaned data, such as a word-embedding algorithm. The word-embedding algorithm can encode the meanings of words in the content as real-valued vectors in a vector space where words similar in meaning are closer to each other in the vector space.

The server can compare the processed content from the web page sections to the shared messages to determine which section is the most semantically similar to the shared messages. In an example, the server can identify the most semantically similar section by calculating a matching score for each section. For example, a section's matching score can be calculated based on the amount of word embedding matches or based on the closeness of the words in the vector space. The section with the highest score can be determined to the most relevant section to the URL recipient based on the context of the conversation in the shared messages.

In an example, the server can modify the file of the web page to make the relevant content easier for the recipient user to identify. In one example, the server can generate a custom preview of the web page based on the highest scoring section. For example, the server can insert Open Graph (“OG”) meta tags into the web page file that point to the highest scoring section. The OG meta tags can be used to create the web site preview. This lets the recipient user see a preview of relevant content on the web page instead of the web page generally.

In one example, the server can highlight relevant content in the web page, such as by highlighting text, changing the background color, and changing the text color so that the text is clearly visible to the user when the web page loads. The server can do this by inserting CSS properties into the web page file. In an example, the server can highlight all content in the web page file that exceed a matching threshold. This can allow the recipient user to easily identify relevant content on the web page across all the sections.

In one example, the server can append the URL with a named anchor so that the web page automatically scrolls to the highest scoring section when the web page loads. This can save the recipient user time and frustration in locating the most relevant portion of the web page.

In an example, the server can save a copy of the modified web page file in a storage location like a web server. The server can send a modified URL to the recipient's user device that points to the modified web page. The agent on the user device can replace the shared URL with the modified URL. This can cause the communication platform to show the custom preview of the web page created by the server. If the recipient user selects or clicks on the preview or the modified URL, the user device can retrieve the modified web page instead of the original web page. The user device can load the modified web page with all the modifications made by the server. In one example, the user device can make a Hypertext Transfer Protocol (“HTTP”) request to retrieve the modified web page from a web server where it is hosted. In one example, the server can send the modified web page to the user device where it can be stored in a local cache. When the user selects the link, the user device can load the modified web page from the local cache instead of making an HTTP request.

The examples summarized above can each be incorporated into a non-transitory, computer-readable medium having instructions that, when executed by a processor associated with a computing device, cause the processor to perform the stages described. Additionally, the example methods summarized above can each be implemented in a system including, for example, a memory storage and a computing device having a processor that executes instructions to carry out the stages described.

Both the foregoing general description and the following detailed description are exemplary and explanatory only and are not restrictive of the examples, as claimed.

### BRIEF DESCRIPTION OF THE DRAWINGS

FIG. 1 is an illustration of a system for providing smart web links.

FIG. 2 is a flowchart of an example method for providing smart web links.

FIG. 3 is a sequence diagram of an example method for providing smart web links.

FIG. 4A is an illustration of an example graphical user interface (“GUI”) of a modified web page using smart web links.

FIG. 4B is an illustration of an example web page preview of a modified web page using smart web links.

### DESCRIPTION OF THE EXAMPLES

Reference will now be made in detail to the present examples, including examples illustrated in the accompanying drawings. Wherever possible, the same reference numbers will be used throughout the drawings to refer to the same or like parts.

Systems and methods presented herein provide smart web links that display the most relevant portion of a shared web page based on the context in which the web page is shared. An agent on a user device can detect a uniform resource locator (“URL”) shared on a communication channel. The agent send the URL and content from the communication channel to a server. The server can retrieve a web page of the URL and identify sections of it. The server can compare the sections to the communication content to determine which section is the most semantically similar. The server can modify the web page to generate a custom preview, highlight the semantically similar content, and cause the web page to automatically scroll to the highest scoring section. The agent can change the shared URL to a new URL that directs to the modified web page.

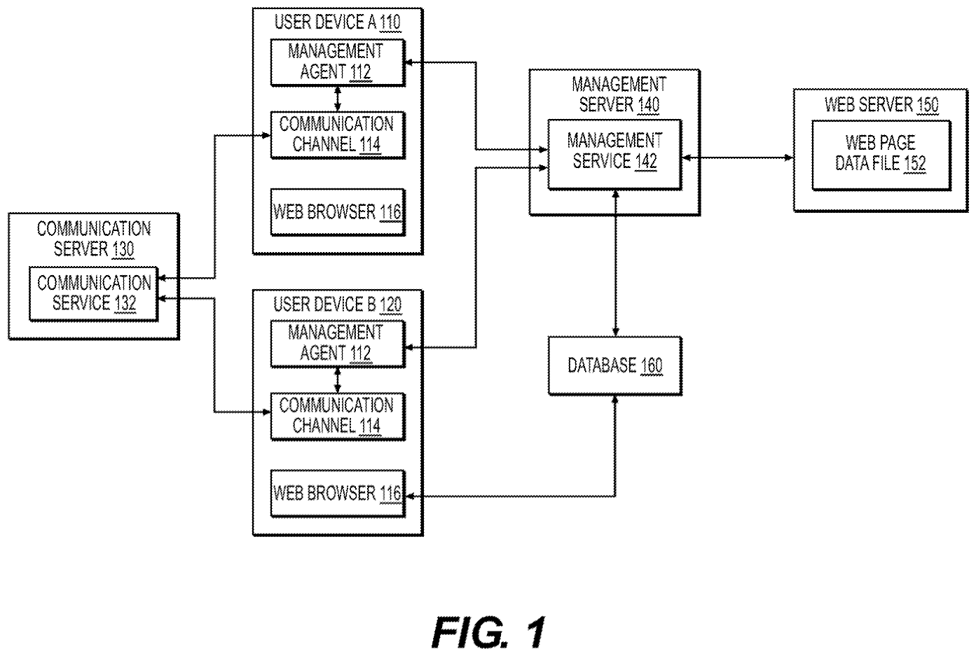

FIG. 1 is an illustration of a system for providing smart web links. Two user devices, a user device A 110 and a user device B 120, can include a communication channel 114. The user devices A 110, B 120 can be one or more processor-based devices, such as a personal computer, tablet, or cell phone. The communication channel 114 can be a dedicated space on a communication software platform for communication between users. For example, the communication channel 114 can be an email chain, instant message conversation, short message service (“SMS”) message conversation, an online forum, comments on a work ticket, and so on. Accordingly, the user devices A 110, B 120 can have one or many communication channels 114 simultaneously. The communication channel 114 can operate through a communication service 132 on a communication server 130. The communication service 132 can facilitate communication of users of the user devices A 110, B 120 by relaying messages between the two. For example, the communication channel 114 can be an email chain and the communication server 130 can be an email exchange server.

In an example, the user devices A 110, B 120 can include a management agent 112. The management agent 112 can be responsible for executing certain management functions on user devices. For example, the user devices A 110, B 120 can be enrolled in a Unified Endpoint Management (“UEM”) system. A management server 140 of the UEM system can enforce security and compliance protocols on the user devices A 110, B 120 through the management agent 112. The management server 140 can be a single server or a group of servers, including multiple servers implemented virtually across multiple computing platforms. The management agent 112 can communicate with a management service 142 to provide this functionality.

In an example, the management agent 112 can monitor messages on the communication channel 114 to identify any URLs sent or received. In one example, access to content in the communication platform can be provided by an operating system of the user devices A 110, B 120. In another example, the communication channel 114 can be an application integrated with the UEM system. The management agent 112 can monitor communications on one or multiple communication platforms 114 on the user devices A 110, B 120.

When the user of user device A 110 sends a message to the user of user device B 120 that contains a URL, the management agent 112 can extract the URL from the message and sent it to the management service 142. In one example, the user device A 110, the user device B 120, or both can send data about communications between users of the two or more devices to the management service 142. Examples of such data can include emails, messages, posts, and others. For example, the URL can be sent in an email chain, and the management agent 112 can send the URL and content and metadata of the emails to the management service 142. Metadata can include information about which device sent each message, when each message was sent, and so on.

The management service 142 can make a hypertext transfer protocol (“HTTP”) call using the URL to retrieve a web page data file (“data file”) 152 from a web server 150. The web server 150 can be a server that hosts the URL and provides data files for web pages upon request. The data file can be for a web page, such as a Hypertext Markup Language (“HTML”) file. Although the data file 152 is described as a HTML file throughout, these references are merely used as examples and are not intended to be limiting in any way. For example, the data file 152 can encompass any data file type used for display purposes, such as an Extensible Markup Language (“XML”) file or JavaScript Object Notation (“JSON”) file.

The management service 142 can be responsible for comparing the data file 152 and the communication content to determine the most relevant portion of the web page for the users. For example, the management service 142 can score each section of the web page based on how closely related the web page section content is to the content of the communications. The management service 142 can use various techniques to compare the contents, such as word-embedding, many-to-one (“N:1”) matching, keyword extraction, named-entity recognition, natural language processing, and so on.

The management service 142 can create a custom version of the web page that directs a user who clicks on the link to the most relevant section. This can be done by creating a modified web page data file (“modified data file”) 162 from the data file 152. For example, the management service 142 can add highlights to the highest scoring section, add a named anchor or URL fragment to cause the web page to automatically display the highest scoring section, and create a custom preview that displays content from the highest scoring section.

In an example, the management service 142 can save the modified data file to a database 160. The database 160 can be part of the management server 140 or its own device, such as a database server. In one example, the database 160 can be a web server that stores web page data files created by the management service 142. For example, the management service 142 can send the modified data file 162 to the database 160. The management service 142 can then send instructions to the management agent 112 on the user devices A 110, B 120 to modify the URL on the communication channel 114. For example, the management agent 112 can change the URL so that it directs to the database 160 instead of the web server 150. Changing the URL can cause the communication channel 114 to generate a preview for the modified data file 162 instead of the data file 152, which can be a preview that displays content from the highest scoring section.

When a user selects the URL inserted by the management agent 112, the user device A 110 or B 120 can make an HTTP request to the database 160, and the database 160 can respond with the modified data file 162. The user device A 110 or B 120 can then display the web page in a web browser 116. The web browser 116 can automatically scroll the web page to the highest scoring section and highlight its content according to the modifications in the data file 162. Where multiple sections have a high enough matching score (e.g., exceeding a threshold), the web browser 116 can highlight those sections as well so that the user can easily identify them when scrolling through the web page.

Although a server example is described throughout, some functions described as being performed by a server can be performed at the management agent 112. For example, the management agent 112 can be configured to retrieve the data file 152, analyze the communication content and the web page content, identify a highest scoring section, modify the data file 152, and store a modified copy 162 in a local cache of the user device A 110, B 120. The management agent 112 can also modify the URL in the communication channel 114 so that it directs to the cached modified data file 162. When a user selects the link, the modified data file 162 can be retrieved from the cache.

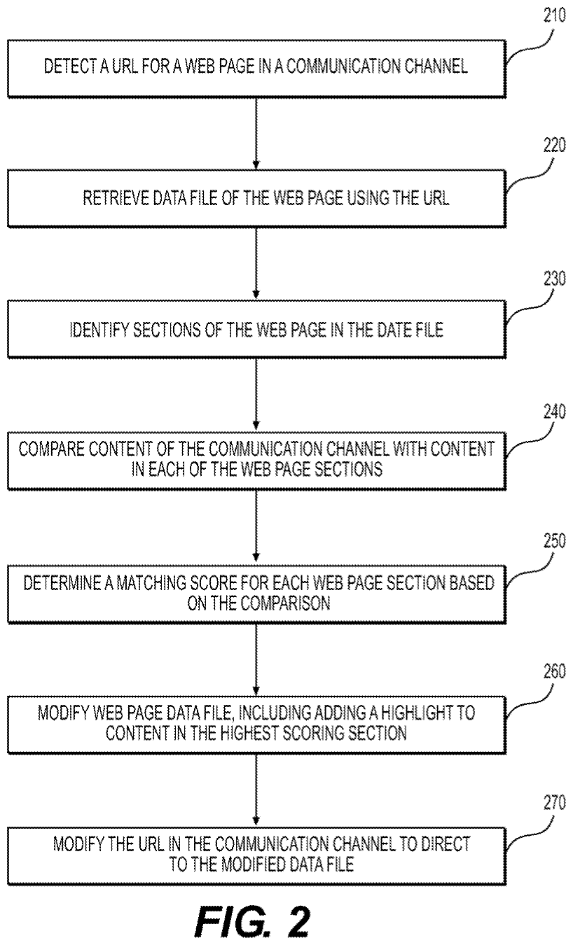

FIG. 2 is a flowchart of an example method for providing smart web links. At stage 110, the management server 140 can detect a URL for a web page in a communication channel. For example, the management agent 112 can monitor messages exchanged on the communication channel 114 of the user devices A 110, B 120. For example, the management agent 112 can monitor emails, instant messages, short message service (“SMS”) messages, and online posts. When the management agent 112 detects a URL on the communication channel 114, the management agent 112 can copy the URL and send it to the management server 140.

In an example, the management agent 112 can also send content from the communication channel 114 to the management server 140. For example, when the URL is sent in an email, the management agent 112 can send content from the body of the email and any other emails in the email chain. As an example, users of the user devices A 110, B 120 can exchange messages, such as emails or instant messages. The user of device A 110 can send a message with a URL to the user of device B 120. The management agent 112 can collect the URL and the messages exchanged in the conversation and send them to the management server 140. Alternatively, an email gateway or some other messaging server used to deliver the messages can send the message content to the management server 140.

At stage 120, the management server 140 can retrieve a data file of the web page using the URL. For example, the management server 140 can make an HTTP request using the URL. The request can be directed to the web server 150, which hosts the web page of the URL. The web server 150 can respond with the data file 152 of the web page. The data file can be an HTML, file, for example.

At stage 130, the management server 140 can identify sections of the web page in the data file 152. For example, the management server 140 can identify predefined sections in the data file 152 by locating HTML elements, such as <h>, <p>, <section>, and <div> tags. The sections can also be divided according to total amount of text, where a threshold number of sentences or words causes the next sentence or paragraph to start a new section. In one example, the management server 140 can filter out sections that are unlikely to include content relevant to the exchanged messaged. For example, the management server 140 can filter out headers and footers. In another example, sections can be filtered out where the number of characters in the section is below a threshold. In one example, filter settings can be defined beforehand by an administrative user.

At stage 140, the management server 140 can compare content on the communication channel with content in each of the web page sections. This can include processing both sets of content using one or more methods. For example, the management server 140 can pre-process the data by cleaning it. Cleaning data includes processes like making all text lower case, tokenization, removing stop words like “the,” “is,” “at,” “which,” and “on,” removing punctuation, and lemmatization.

In an example, after the cleaning the data, the management server 140 can process the data using NLP techniques. For example, the management server 140 can implement word embedding where individual words are represented as real-valued vectors in a predefined vector space. The real-valued vector can encode the meaning of the word so that other words that are closer in the vector space should have similar meanings. Some examples of word embedding algorithms include Word2vec, Glove, TF-IDF, and Doc2Vec. In the data file 152, the management server 140 can treat the entire web page as a single document or file when applying NLP techniques. Alternatively, the management server 140 apply NLP techniques to each section in isolation.

In an example, the management server 140 can compare the processed data from the communications and the data file 152. In one example, this this can be a semantic comparison. For example, the management server 140 can match embeddings taken from the various sections of the web page against the embeddings of the communication content. This can be done using many-to-one (N:1) matching, as an example. For example, each section of the web page can have its own set of embeddings, but the communication content can have just one set. The communication embeddings can match to embeddings in any of the web page sections, but the web page sections can only match to the one set in the communication content.

In an example, other processing techniques can be used to process the data as well, such as keyword extraction and Named Entity Recognition (“NER”). The management server 140 can also implement other comparison techniques determine a high-level match, such as a sentiment analysis or categorizing sections based on topics.

At stage 150, the management server 140 can determine a matching score for each web page section based on the comparison. In an example, the matching score for each section can be the number of embedding matches it has with the communication content. The highest score can indicate the web page section that is semantically closest to the communication content.

In one example, the management server 140 can assign weights to sections of the web page. These weights can be used in determining matching scores. For example, for each section the management server 140 can multiply its weight by the number of embedding matches to get the matching score. Weights can be determined based on various factors, such as HTML element tags and total number of characters.

At stage 160, the management server 140 can modify the data file 152. In one example, this can include highlighting content in the highest scoring section. In an example, highlighting content in the highest scoring section can include highlighting text, changing the background color, and changing the text color so that the text is clearly visible to the user when the web page loads. In one example, this can be done by inserting CSS properties into the data file 152.

In an example, the management server 140 can highlight content in one or multiple sections. For example, when two or more sections have the same highest matching score, both can be highlighted. In another example, sections with a score within a threshold amount of the actual highest score can be highlighted. For example, the management server 140 can highlight content in sections with a matching score within 5% of the highest scoring section score. This can be especially helpful in instances when several non-continuous sections in the original webpage match the content from the communication channel 114. The user can easily identify all sections of the web page with relevant content by scrolling through the page and finding highlighted sections.

In an example, modifying the data file 152 can include generating a custom preview of the web page. For example, many communication platforms generate and display a preview of a web page when a URL is shared. The host of the web site can control what displays in a web site preview using Open Graph (“OG”) meta tags. In an HTML file, OG meta tags include an “og:” before the property name. The following is an example HTML script that can be inserted into the data file 152 to create a custom preview of the highest scoring section:

<meta property=“og:title” content=“[section title]”/>
<meta property=“og:description” content=“[section description]”/>
<meta property=“og:image content=“[section image file name]”/>

In the example above, the management server 140 can insert a section heading or title of the highest scoring section in the “[section title]” location. The management server 140 can identify the section heading using a section heading HTML element tag, such as a <s> or <section> tag, and copy the text from the tag into the “[section title]”. The management server 140 can insert content in the “[section description]” location in a similar manner. For example, the management server 140 can locate a paragraph tag, such as <p> tag inside of the section tag, and insert a portion of the text according to the number of characters allowed for the preview. In an example where the section includes a description in the web page, the management server 140 can simply copy that over. Where the web page includes an image in the highest scoring section, the management server 140 can copy the file name to the “[section image file name]” location.

In an example, the modifying the data file 152 can include configuring the web page to automatically scroll (“autoscroll”) to the highest scoring section when the web page is loaded. The management server 140 can do this using a named anchor (also called a URL fragment), for example. This can be done by adding hash (#) character followed by an identifier of the highest scoring section. For example, the URL http://www.webpage.com/subpage#identifier would load the website webpage.com/subpage and automatically scroll to a portion of the web page with an element “id=identifier.” The management server 140 can append to the URL a named anchor with the text of the “id” element of the highest scoring section. In an instance where an “id” element does not exist in the HTML of the highest scoring section, the management server 140 can create and insert one.

In an example, after modifying the data file 152 (which becomes the modified file 162), the management server 140 can save the modified data file 162 to the database 160. At stage 170, the management server 140 can modify the URL in the communication channel 114 to direct to the modified data file 162. In an example, the management server 140 can insert a domain into the URL that directs it to database 160. As an example, the database 160 can be, or connected to, a web server, such as a cloud-based web server, that hosts the web page for the modified data file 162. The domain for the database 160 can be newdomain.com. Using the URL example above as the URL of the original data file 152, the management server 140 can modify the URL to http://www.newdomain.webpage.com/subpage#identifier. Using this method, modified data files 162 can be hosted at the database 160 with their original URL modified to include the domain of the database 160 and a named anchor. This method is merely an example, and other methods can be used to redirect the URL to the modified data file 162. For example, the management agent 112 can cache a copy of the web page at the user devices A 110, B 120, and selecting the URL can pull the modified data file 162 from the cache.

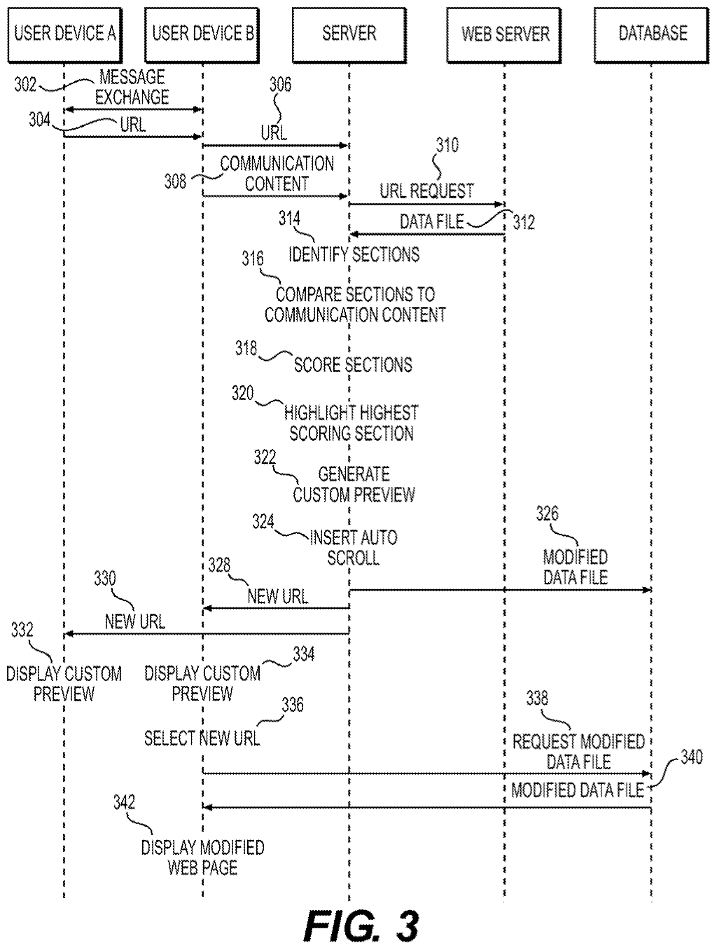

FIG. 3 is a sequence diagram of an example method for providing smart web links. At stage 302, the user devices A 110, B 120 can exchange messages. For example, user of each of the user devices A 110, B 120 can exchange chat messages or emails, or write comments in a work ticket or web forum. Although two user devices are described, this can include more users and devices. For example, the messages can be exchanged through a gateway or messaging server. At stage 304, the user on user device A 110 can send a URL to the user device B 120 on the communication channel 114. For example, the user can send a message or email with the URL, or post the URL in a ticket or web forum.

At stage 306, the user device B 120 can send the URL to the management server 140. For example, the management agent 112 on the user device B 120 can detect the URL, copy it, and send it to the management server 120. In one example, the management agent 112 can detect the URL by monitoring the communication channel 114 and detecting anything sent in the format of a URL. The detection and stage 306 can alternatively be done by the gateway or messaging server.

At stage 308, the user device B 120 can send communication content related to the exchanged messages to the management server 140. The communication content can include messages exchanged or shared on the communication channel 114 leading up to the URL being sent. In an example where the URL is sent in an email, the management agent 112 can collect and send any emails in the same email chain that were exchanged before the URL was sent and any content from the email that included the URL. In an example where the URL is sent in a group or private chat, the management agent 112 can collect and send messages exchanged in the chat before the URL was shared. In one example, the management agent 112 can be configured to retrieve messages with a specified amount of time or a specified amount of the most recent messages sent before the URL was sent. For example, the management agent 112 can collect the most recent ten messages or messages collected that were sent on the same day, within an hour, or within ten minutes of the URL being sent. These settings can be set by an administrator, in an example.

At stage 310, the management server 140 can make an HTTP request using the URL to retrieve the web page associated with the URL. The HTTP request can arrive at the web server 150 that hosts the web page. At stage 312, the web server 150 can send the data file 152 for the web page to the management server 140. In an example, the data file 152 can be an HTML file.

At stage 314, the management server 140 can identify sections of the web page in the data file 152. For example, the management server 140 can identify predefined sections in the data file 152 by locating HTML element tags, such as <h>, <p>, <section>, and <div> tags. In one example, the management server 140 can filter out sections that are unlikely to include content relevant to the exchanged messaged such as headers, footers, and sections can with few characters than a threshold amount.

At stage 316, the management server 140 can compare the web page sections to the communication content. In an example, the comparison can include multiple processing stages. For example, a first process can be a pre-processing stage that includes cleaning the data. This can include processes like making all text lower case, tokenization, removing stop words like “the,” “is,” “at,” “which,” and “on,” removing punctuation, and lemmatization.

A second process can include using NLP techniques to characterize the content. On such technique can be word-embedding, which is where individual words are represented as real-valued vectors in a predefined vector space. The real-valued vector can encode the meaning of the word so that other words that are closer in the vector space should have similar meanings. Some examples of word embedding algorithms include Word2vec, Glove, TF-IDF, and Doc2Vec. Other methods can be optionally included in processing the data. For example, the management server 140 can also perform a keyword extraction or NER.

In an example, the data comparison can be a semantic comparison that attempts to match meanings of the web page sections to the exchanged messages. For example, the management server 140 can match embeddings taken from the various sections of the web page against the embeddings of the communication content. This can be done using many-to-one (N:1) matching, as an example. For example, each section of the web page can have its own set of embeddings, but the communication content can have just one set. The communication embeddings can match to embeddings in any of the web page sections, but the web page sections can only match to the one set in the communication content.

At stage 318, the management server 140 can determine matching scores for the web page sections. In an example, the matching score for each section can be the number of embedding matches it has with the communication content. The highest score can indicate the web page section that is semantically closest to the communication content.

In one example, the management server 140 can assign weights to the web page sections. The management server 140 can multiple the number of matched embeddings with the weight to get a matching score for a section. Weights can be determined based on various factors, such as HTML, element tags and total number of characters. In one example, the management server 140 can process the data using multiple methods, and each method can be assigned a weight. For example, the management server 140 calculate one score based on a semantic similarity analysis and another based on a keyword match. The semantic similarity score can be given a greater weight than the keyword match score or vice versa. The matching score for each section can then be the aggregate of the weighted scores.

At stage 320, the management server 140 can modify the data file 152 to highlight content in the highest scoring section. For example, the management server 140 can insert CSS properties into the data file 152 that highlights text, changes the background color, or changes the text color of the highest scoring section so that the text is clearly visible to the user when the web page is displayed. The management server 140 can highlight one or multiple sections. For example, the management server 140 can highlight content in all sections that fall above a threshold, such as within 10% or within five matching score points of the highest scoring section. This can help prevent content relevant to the communication between the users from being excluded.

At stage 322, the management server 140 can generate a custom preview for the URL based on the highest scoring section. For example, the management server 140 can insert OG meta tags based on the highest scoring section. The OG meta tags can identify a title of the highest scoring section, provide a description or some text from the highest scoring section, and include an image file (if any) from the highest scoring section. If the communication channel 114 has the capability of providing web site previews from posted URLs, the communication channel can identify the OG meta tags and present the custom preview accordingly.

At stage 324, the management server 140 can configure the web page to automatically scroll to the highest scoring section when the web page is retrieved. In one example, this can be done using a named anchor. For example, the management server can append the URL with a hash symbol (#) followed by an “id” element associated with the highest scoring section. If the highest scoring section does not yet have an “id” element, the management server 140 can create for the section and insert it into the data file 152.

At stage 326, the management server 140 can send the modified data file 162 of the web page to the database 160. In an example, the database 160 can store the modified data file 162 for a specified amount of time. For example, the content for the web page may only be relevant to a specific conversation between the users, and saving the modified data file 162 indefinitely can waste valuable storage space. The database 160 can be configured to delete the modified data file 162 after a specified amount of time, such as a day, a week, or a month. In one example, the database 160 can dedicate a specified amount of storage space to modified web page data files 162 and do a rolling time-based removal. For example, if storing a new modified data file 162 would cause the used storage space to exceed its allotted amount, the database 160 can be configured to delete the oldest modified data files 162 until enough space is available.

At stage 328, the management server 140 can send a new URL for the modified web page to the user device B 120. At stage 330, the management server 140 can also send the new URL to the user device A 110. The new URL can be directed to the modified data file 162 on the database 160. In one example, the format of the new URL can be the same as the original URL, but the management server 140 can insert a domain into the original URL that causes it to direct to the modified data file 162. As an example, if the original URL is http://www.webpage.com and the domain for the modified data file 162 is newdomain.com, the original URL can be modified to http://www.newdomain.webpage.com.

In an example, the management server 120 can send the new URL to the management agent 112 on the user devices A 110, B 120. The management agent 112 can then insert the new URL into the communication channel 114. In an example, this can include replacing the original URL with the new URL. At stages 332 and 334, the user devices A 110 and B 120 can display the custom preview on the communication channel 114. In one example, the communication platform 114 can retrieve the modified data file 162 from the database 160 and detect the OG meta tags. The communication channel 114 can then create the custom preview based on the OG meta tags. In one example, the communication channel 114 can request data for the preview only, and the database 160 can use the OG meta tags to identify the data for the custom preview and send it to the communication channel 114.

At stage 336, the user of user device B 120 can select the new URL. For example, the user can click or select the URL or the custom preview generated in the communication channel 114. In response, the user device B 120 can make an HTTP request for the modified web page data file 162 using the new URL, at stage 338. In an example where the modified data file 162 is already retrieved at stage 334, the user device B 120 can retrieve it from a storage component of the user device B 120, such as a local cache. At stage 340, the database can send the modified data file 352 to the user device B 120.

At stage 342, the user device B 120 can display the modified web page. This can be done in the web browser 116, for example. The web browser 116 can load the web page and apply the highlights inserted at stage 320. The web browser 116 can also detect the named anchor and automatically scroll to the highest scoring section. The user will therefore be shown the most relevant portion of the web page after selecting the URL based on the conversation leading up to the URL being shared.

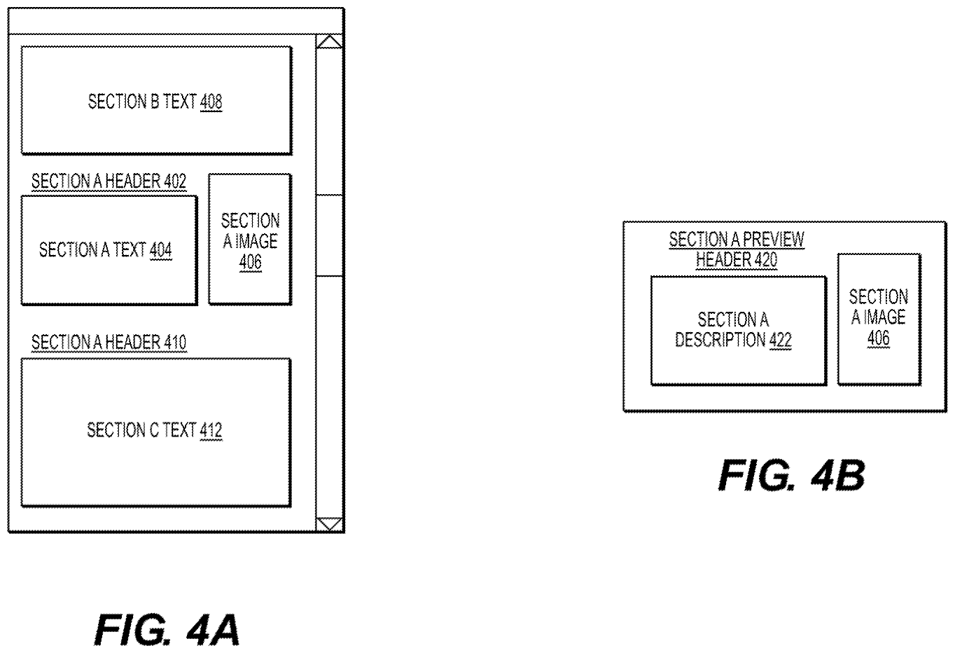

FIG. 4A is an illustration of an example graphical user interface (“GUI”) 400 of a modified web page using smart web links. In the modified web page shown in GUI 400, section A header 402, section A text 404, and section A image 406 are components of the web page section that received the highest matching score. When a user selects the associated smart web link, the GUI 400 can automatically scroll to this section, as shown. As shown in FIG. 4A, the section A text 404 is highlighted, unlike the section B text 408 in the previous section and the section C text 412 in the subsequent section.

FIG. 4B is an illustration of an example web page preview of the GUI 400. The preview includes a section A preview header 420, a section A description 422, and the section A image 406. The section A preview header 420 corresponds to the section A header 402. The section A description 422 displays a description of the section A text 404. In one example, the section A description 422 can be retrieved from metadata in an HTML, file of the web page. In another example where no such description exists, the section A description 422 can display the first text from the section A text 404 up to a predetermined number of characters. As shown in FIG. 4B, the section A description 422 need not be highlighted.

Other examples of the disclosure will be apparent to those skilled in the art from consideration of the specification and practice of the examples disclosed herein. Though some of the described methods have been presented as a series of steps, it should be appreciated that one or more steps can occur simultaneously, in an overlapping fashion, or in a different order. The order of steps presented are only illustrative of the possibilities and those steps can be executed or performed in any suitable fashion. Moreover, the various features of the examples described here are not mutually exclusive. Rather any feature of any example described here can be incorporated into any other suitable example. It is intended that the specification and examples be considered as exemplary only, with a true scope and spirit of the disclosure being indicated by the following claims.

1. A method for providing smart web links, comprising:
detecting a uniform resource locator (“URL”) for a web page in a communication channel;
retrieving a data file of the web page using the URL;
identifying a plurality of sections of the web page in the data file;
comparing content on the communication channel with content in each of the plurality of web page sections;
determining a matching score for each of the plurality of web page sections based on the comparison;
modifying the data file of the web page, including adding a highlight to content in a highest scoring section of the plurality; and
modifying the URL in the communication channel to direct to the modified data file.

2. The method of claim 1, wherein modifying the data file includes inserting a named anchor corresponding to the highest scoring section.

3. The method of claim 1, wherein modifying the data file includes generating a custom preview of the modified web page, the custom preview displaying content related to the highest scoring section.

4. The method of claim 3, wherein the custom preview is generated by inserting Open Graph meta tags corresponding to the highest scoring section.

5. The method of claim 1, wherein comparing content on the communication channel with content in each of the plurality of web page sections comprises:
creating embeddings by applying a word-embedding algorithm to the content on the communication channel and the content in each of the plurality of web page sections, wherein each embedding encodes a meaning of a corresponding word; and
comparing embeddings for the content on the communication channel to embeddings for content in each of the plurality of web page sections.

6. The method of claim 1, wherein determining the matching score for each of the plurality of web page sections comprises:
matching, based on the comparison, embeddings for the content on the communication channel with embeddings for content in each of the plurality of web page sections; and
calculating a number of matches for each of the plurality of web page sections, wherein the matching score for each web page section in the plurality of web page sections corresponds to the number of matches for the web page section.

7. The method of claim 6, wherein calculating the number of matches for each of the plurality of web page sections further comprises:
assigning a weight to each of the plurality of web page sections; and
multiplying, for each of the plurality of web page sections, the number of matches by the assigned weight of the web page section.

8. A non-transitory, computer-readable medium containing instructions that, when executed by a hardware-based processor, performs stages for providing smart web links, the stages comprising:
detecting a uniform resource locator (“URL”) for a web page in a communication channel;
retrieving a data file of the web page using the URL;
identifying a plurality of sections of the web page in the data file;
comparing content on the communication channel with content in each of the plurality of web page sections;
determining a matching score for each of the plurality of web page sections based on the comparison;
modifying the data file of the web page, including adding a highlight to content in a highest scoring section of the plurality; and
modifying the URL in the communication channel to direct to the modified data file.

9. The non-transitory, computer-readable medium of claim 8, wherein modifying the data file includes inserting a named anchor corresponding to the highest scoring section.

10. The non-transitory, computer-readable medium of claim 8, wherein modifying the data file includes generating a custom preview of the modified web page, the custom preview displaying content related to the highest scoring section.

11. The non-transitory, computer-readable medium of claim 10, wherein the custom preview is generated by inserting Open Graph meta tags corresponding to the highest scoring section.

12. The non-transitory, computer-readable medium of claim 8, wherein comparing content on the communication channel with content in each of the plurality of web page sections comprises:
creating embeddings by applying a word-embedding algorithm to the content on the communication channel and the content in each of the plurality of web page sections, wherein each embedding encodes a meaning of a corresponding word; and
comparing embeddings for the content on the communication channel to embeddings for content in each of the plurality of web page sections.

13. The non-transitory, computer-readable medium of claim 8, wherein determining the matching score for each of the plurality of web page sections comprises:
matching, based on the comparison, embeddings for the content on the communication channel with embeddings for content in each of the plurality of web page sections; and
calculating a number of matches for each of the plurality of web page sections, wherein the matching score for each web page section in the plurality of web page sections corresponds to the number of matches for the web page section.

14. The non-transitory, computer-readable medium of claim 13, wherein calculating the number of matches for each of the plurality of web page sections further comprises:
assigning a weight to each of the plurality of web page sections; and
multiplying, for each of the plurality of web page sections, the number of matches by the assigned weight of the web page section.

15. A system for providing smart web links, comprising:
a memory storage including a non-transitory, computer-readable medium comprising instructions; and
a computing device including a hardware-based processor that executes the instructions to carry out stages comprising:
detecting a uniform resource locator (“URL”) for a web page in a communication channel;
retrieving a data file of the web page using the URL;
identifying a plurality of sections of the web page in the data file;
comparing content on the communication channel with content in each of the plurality of web page sections;
determining a matching score for each of the plurality of web page sections based on the comparison;
modifying the data file of the web page, including adding a highlight to content in a highest scoring section of the plurality; and
modifying the URL in the communication channel to direct to the modified data file.

16. The system of claim 15, wherein modifying the data file includes inserting a named anchor corresponding to the highest scoring section.

17. The system of claim 15, wherein modifying the data file includes generating a custom preview of the modified web page, the custom preview displaying content related to the highest scoring section.

18. The system of claim 17, wherein the custom preview is generated by inserting Open Graph meta tags corresponding to the highest scoring section.

19. The system of claim 15, wherein comparing content on the communication channel with content in each of the plurality of web page sections comprises:
creating embeddings by applying a word-embedding algorithm to the content on the communication channel and the content in each of the plurality of web page sections, wherein each embedding encodes a meaning of a corresponding word; and
comparing embeddings for the content on the communication channel to embeddings for content in each of the plurality of web page sections.

20. The system of claim 15, wherein determining the matching score for each of the plurality of web page sections comprises:
matching, based on the comparison, embeddings for the content on the communication channel with embeddings for content in each of the plurality of web page sections; and
calculating a number of matches for each of the plurality of web page sections, wherein the matching score for each web page section in the plurality of web page sections corresponds to the number of matches for the web page section.
